(19) United States
(12) Patent Application Publication
(10) Pub. No.: US 2025/0008588 A1
(43) Pub. Date: Jan. 2, 2025

(54) Managing A Communication Link With A Network

(71) Applicant: QUALCOMM Incorporated, San Diego, CA (US)

(72) Inventors: Surendra KOMPALA, Fremont, CA (US); Sachin JAIN, Milpitas, CA (US); Bhupesh Manoharlal UMATT, Poway, CA (US); Ankit SHARMA, Sunnyvale, CA (US)

(21) Appl. No.: 18/341,909

(22) Filed: Jun. 27, 2023

(51) Int. Cl. H04W 76/16; H04W 76/18

(52) U.S. Cl. CPC H04W 76/16; H04W 76/18

(57) ABSTRACT

Various aspects include methods for managing communication links with different networks. A user equipment (UE) processor may start a first retry timer in a first network communication module in response to receiving a connection reject message from a first communication network, send a value of the first retry timer to a second network communication module, start a second retry timer in the second network communication module based on the value of the first retry timer, send a service request from the second network communication module to a second communication network, and send a connection success message from the second network communication module to the first network communication module upon establishing a communication link with the second communication network before the second retry timer expires. The first communication network may be a terrestrial cellular network and the second communication network may be a satellite communication network.

### BACKGROUND

User equipment (UE), such as mobile communication devices, can be configured to communicate with a variety of communication networks, such as cellular networks using Long Term Evolution (LTE), Fifth Generation (5G) New Radio (NR), satellite communication network, Wireless Large Area Networks (WLANs) using a protocol in the Institute of Electrical and Electronics Engineers (IEEE) 802 family, and other suitable networks. In some cases, a UE may attempt to establish communication with a second network if an attempt to establish communication with a first network fails. However, the failure to establish communication with the first network also may trigger the UE to start a retry timer, after which the UE reattempts to establish communication with the first network. Uncoordinated attempts to establish communication with the first network and with the second network may increase network congestion in the first and/or the second communication network.

### SUMMARY

Various aspects include methods performed by a user equipment (UE) for managing a communication link with a network. Various aspects may include, in response to receiving a connection reject message from a first communication network by a first network communication module, starting in the first network communication module a first retry timer for a time period after which the first network communication module will send a service request to the first communication network, sending a value of the first retry timer from the first network communication module to a second network communication module, wherein the value of the first retry timer indicates an expiration time of the first timer, starting a second retry timer in the second network communication module based on the value of the first retry timer, sending a service request from the second network communication module to a second communication network; and sending a connection success message from the second network communication module to the first network communication module in response to establishing a communication link with the second communication network before the second retry timer expires.

Some aspects may include, in response to receiving a connection reject message from the second communication network by the second network communication module, sending a connection failure message to the first network communication module. Some aspects may include sending a value of the second retry timer to the first communication module. Some aspects may include sending a connection request message from the first network communication module to the first communication network in response to the first retry timer expiring.

Some aspects may include, in response to the first retry timer expiring before the first network communication module receives any message from the second network communication module, sending an abort message from the first network communication module to the second network communication module to inform the second network communication module to abort a service request process with the second communication network.

In some aspects, the first network communication module and the second network communication module may communicate via a communication interface. In some aspects, the communication interface may be managed by a unified messaging application.

In some aspects, the first communication network may be a terrestrial cellular communication network, the first network communication module may be a terrestrial cellular communication module configured to communicate with the terrestrial cellular communication network, the second communication network may be a satellite communication network, and the second network communication module may be a satellite communication module configured to communicate with the satellite communication network.

Further aspects include a UE having a processor configured to perform one or more operations of any of the methods summarized above. Further aspects include processing devices for use in a UE configured with processor-executable instructions to perform operations of any of the methods summarized above. Further aspects include a non-transitory processor-readable storage medium having stored thereon processor-executable instructions configured to cause a processor of a UE to perform operations of any of the methods summarized above. Further aspects include a UE having means for performing functions of any of the methods summarized above. Further aspects include a system on chip for use in a UE and that includes a processor configured to perform one or more operations of any of the methods summarized above.

### BRIEF DESCRIPTION OF THE DRAWINGS

FIG. 1A is a system block diagram illustrating an example communications system suitable for implementing any of the various embodiments.

FIG. 1B is a system block diagram illustrating an example disaggregated base station architecture suitable for implementing any of the various embodiments.

FIG. 2 is a component block diagram illustrating an example computing and wireless modem system suitable for implementing any of the various embodiments.

FIG. 3 is a component block diagram illustrating a software architecture including a radio protocol stack for the user and control planes in wireless communications suitable for implementing any of the various embodiments.

FIG. 4 is a block diagram illustrating aspects of a system for managing a communication link with a network in accordance with various embodiments.

FIG. 5 is a message flow diagram illustrating communications and operations in a method that may be performed by a processor of a UE for managing communication links with two different networks in accordance with various embodiments.

FIG. 6A is a process flow diagram illustrating a method that may be performed by a processor of a UE for managing communication links with two different networks in accordance with various embodiments.

FIGS. 6B and 6C are process flow diagrams illustrating operations that may be performed by a processor of a UE modem as part of the method for managing communication links with two different networks in accordance with various embodiments.

FIG. 7 is a component block diagram of a UE suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include a UE that is configured to communicate with a first communication network and a second communication network. In some embodiments, the UE may be configured to communicate with the first communication network via a first network communication module, and with the second communication network via a second network communication module. The UE may be configured to send and/or receive information between the first network communication module and the second network communication module including context information of attempt(s) by the first network communication module to establish communication with the first communication network and/or attempt(s) by the second network communication module or the second communication network. The first network communication module and the second network communication module may be configured to send and receive information to each other via a communication interface. In some embodiments, the context information may include a value related to a retry timer or a retry counter. The first network communication module and/or the second network communication module may start a retry timer or retry counter in response to receiving a connection reject message from a communication network. The retry timer or retry counter may indicate a period of time during which the first network communication module or the second network communication module will not reattempt to establish communication with the first or second communication network. Configuring the UE to enable communication between the first network communication module and of the second network communication module may enable the UE to reduce a time for establishing communication with the first communication network or the second communication network. In some embodiments, the first network may be a cellular communication network, such as a 5G network, and the second network may be a satellite communication network.

The term “user equipment” (UE) is used herein to refer to any one or all of wireless communication devices, wireless appliances, cellular telephones, smartphones, portable computing devices, personal or mobile multi-media players, laptop computers, tablet computers, smartbooks, ultrabooks, palmtop computers, wireless electronic mail receivers, multimedia Internet-enabled cellular telephones, extended reality (XR) head-mounted displays and glasses, entertainment devices (for example, wireless gaming controllers, music and video players, satellite radios, etc.), wireless router devices, medical devices and equipment, wearable devices including smart watches, smart clothing, smart glasses, and smart wrist bands, wireless-network enabled Internet of Things (IoT) devices including smart meters/sensors, industrial manufacturing equipment, large and small machinery and appliances for home or enterprise use, wireless communication elements within vehicles, wireless devices affixed to or incorporated into various mobile platforms, and similar electronic devices that include a memory, wireless communication components and a programmable processor.

The term “system on chip” (SOC) is used herein to refer to a single integrated circuit (IC) chip that contains multiple resources or processors integrated on a single substrate. A single SOC may contain circuitry for digital, analog, mixed-signal, and radio-frequency functions. A single SOC also may include any number of general purpose or specialized processors (digital signal processors, modem processors, video processors, etc.), memory blocks (such as ROM, RAM, Flash, etc.), and resources (such as timers, voltage regulators, oscillators, etc.). SOCs also may include software for controlling the integrated resources and processors, as well as for controlling peripheral devices.

The term “system in a package” (SIP) may be used herein to refer to a single module or package that contains multiple resources, computational units, cores or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SOCs coupled together via high speed communication circuitry and packaged in close proximity, such as on a single motherboard or in a single wireless device. The proximity of the SOCs facilitates high speed communications and the sharing of memory and resources.

As used herein, the terms “network,” “system,” “wireless network,” “cellular network,” and “wireless communication network” may interchangeably refer to a portion or all of a wireless network of a carrier associated with a wireless device and/or subscription on a wireless device. The techniques described herein may be used for various wireless communication networks, such as Code Division Multiple Access (CDMA), time division multiple access (TDMA), FDMA, orthogonal FDMA (OFDMA), single carrier FDMA (SC-FDMA) and other networks. In general, any number of wireless networks may be deployed in a given geographic area. Each wireless network may support at least one radio access technology, which may operate on one or more frequency or range of frequencies. For example, a CDMA network may implement Universal Terrestrial Radio Access (UTRA) (including Wideband Code Division Multiple Access (WCDMA) standards), CDMA2000 (including IS-2000, IS-95 and/or IS-856 standards), etc. In another example, a TDMA network may implement Enhanced Data rates for Global System for Mobile communications (GSM) Evolution (EDGE). In another example, an OFDMA network may implement Evolved UTRA (E-UTRA) (including LTE standards), Institute of Electrical and Electronics Engineers (IEEE) 802.11 (Wi-Fi), IEEE 802.16 (WiMAX), IEEE 802.20, Flash-OFDM®, etc. Reference may be made to wireless networks that use LTE standards, and therefore the terms “Evolved Universal Terrestrial Radio Access,” “E-UTRAN” and “eNodeB” may also be used interchangeably herein to refer to a wireless network. However, such references are provided merely as examples, and are not intended to exclude wireless networks that use other communication standards. For example, while various Third Generation (3G) systems, Fourth Generation (4G) systems, and Fifth Generation (5G) systems are discussed herein, those systems are referenced merely as examples and future generation systems (e.g., sixth generation (6G) or higher systems) may be substituted in the various examples.

User equipment (UE), such as mobile communication devices, can be configured to communicate with a variety of communication networks, such as cellular networks using Long Term Evolution (LTE), Fifth Generation (5G) New Radio (NR), satellite communication network, Wireless Large Area Networks (WLANs) using a protocol in the Institute of Electrical and Electronics Engineers (IEEE) 802 family, and other suitable networks. A failure to establish communication with the first network also trigger the UE to start a retry timer that measures a time period after which the UE may reattempt to establish communication with the first network. For example, a first network communication module (e.g., a 5G module) configured to manage communication with the first communication network may attempt to establish communication with the first communication network, and may receive a connection reject message from the first communication network. The first network communication module may start a retry timer (e.g., a back-off timer or another suitable timer) in response to receiving the connection reject message. While the retry timer is running (i.e., before the retry timer expires) the first network communication module may be configured to wait (to not reattempt) to establish communication with the first communication network.

However, in some cases, a UE may attempt to establish communication with a second network, such as a satellite communication network, if an attempt to establish communication with a first network fails. For example, some UEs may be configured to switch to a second network communication module, such as a satellite communication module, that is configured to establish and manage communication with the second communication network, such as a satellite communication network. However, in UE devices in which the first and second networks involve very different communication protocols and radios, such as when the first network is a terrestrial cellular communication network (e.g., 5G, GSM, etc.) and the second network is a satellite communication network (e.g., Iridium®, StarLink®, Inmarsat®, etc.) the first network communication module and the second network communication module are typically not configured to communicate with each other. In such cases, when the UE switches from the first network communication module to the second network communication module, the first network medication module may lose (e.g., may delete) its retry timer information. Further, the first network communication module is unable to convey any context information about the attempts to establish communication with the first communication network, or any information about the retry timer. Under circumstances in which the UE switches back to the first network communication module, having lost any retry timer information, the first network communication module may attempt to reestablish communication with the first communication network right away, which may exacerbate wireless communication link congestion.

As an example, the UE may attempt to establish communication with a cellular communication network (the first communication network). In response to receiving a connection reject message from the cellular network due to network failure or network congestion, the UE may start a retry timer (in the first network communication module) for a time period after which the first network communication module will send another service request to the cellular communication network. The UE also may switch to a second network communication module and attempt to establish communication with a satellite communication network (the second communication network). When this happens, the first network communication module may lose any earlier context information about the attempts of the first network communication module to establish communication with the cellular network. Should the UE switch back to the first communication module before the second network communication module establishes communication with the satellite network, the first network communication module may immediately attempt to establish communication with the cellular network, without regard for the (now lost) retry timer information and any other cellular network context.

Various embodiments include a UE that is configured to communicate with a first communication network via a first network communication module, and with a second communication network via a second network communication module. The UE may attempt to establish communication with the first communication network, for example, by sending a service request to the first communication network.

If the first communication network is unavailable, the network may send to the UE a connection reject message. For example, the connection reject message may be a “CM SERVICE REJ” message, which may be configured in accordance with a technical standard such as Third Generation Partnership Project (3GPP) Technical Specification (TS) 24.008 or another suitable technical specification. As another example, the connection reject message may be a Radio Resource control (RRC) message, such as “RRCReject” or another suitable message, which may be configured in accordance with a technical standard such as 3GPP TS 38.331 or another suitable technical specification. In some embodiments, the connection reject message may include an indication of a reason for the rejection. In some embodiments, the indication may include a reject cause information element. As one example, connection reject message may indicate that the rejection is due to network failure or network congestion.

In response to receiving a connection reject message from the first communication network (e.g., by the first network communication module), the UE may start a first retry timer in the first network communication module that indicates a time period after which the first network communication module will send a service request to the first communication network. In some embodiments, a value of the first retry timer may be provided by the first communication network, such as in a LOCATION UPDATING REJECT or CM SERVICE REJECT message, or in an “Extended wait time” value by lower protocol layers, or in a “WaitTime” or “RejectWaitTime” value. In some embodiments, the first network module may select the value of the first retry timer randomly from a default value range, such as 15-30 minutes. In some embodiments, the first retry timer may be a retry counter. In some embodiments, the retry counter may include a value that indicates or represents unsuccessful retry attempts.

The first network communication module and the second network communication module may be configured to send and receive information to each other via a communication interface. In some embodiments, the communication interface may be managed by a unified messaging application. In some embodiments, the first network communication module may send a value of the first retry timer to the second network communication module. In some embodiments, the value of the first retry timer may indicate an expiration time of the first timer. The UE may continue (maintain) the first retry timer in the first network medication module. The UE may start a second retry timer in the second network communication module based on the value of the first retry timer. The UE may send a service request from the second network communication module to the second communication network. In response to establishing a communication link with the second communication network before the second retry timer expires, the UE may send the connection success message from the second network communication to the first network communication module.

In some embodiments, the second network communication module may send a connection failure message to the first communication module in response to receiving a connection reject message from the second communication network by the second network communication module. In some embodiments, the second network communication module may send a value of the second retry timer to the first communication module. In some embodiments, the value of the second retry timer may enable the first communication module to adjust the first retry timer or to alter the first retry timer based on the value of the second retry timer.

In some embodiments, in response to the first retry timer expiring, the first network communication module may send a connection request message to the first communication network. For example, having received a connection failure message from the second network communication module, when (or after) the first retry timer expires, the first network communication module may send a connection request message (which may be a reattempt to establish communication) to the first communication network.

In some embodiments, in response to the first retry timer expiring before the first network communication module receives any message from the second network communication module, the first network communication module may send an abort message to the second network communication module to inform the second network communication module to abort a service request process with the second communication network. In some embodiments, after sending the abort message to the second network medication module, the first communication module may send a connection request message to the first communication network.

In some embodiments, the first network communication network is a terrestrial cellular communication network, first network communication module is a cellular communication radio and modem, the second network communication network is a satellite communication network, and the second network communication module is a satellite communication radio and modem.

Various embodiments may improve the operation of the UE by improving the efficiency and reducing latency for establishing communication with the first communication network or the second communication network. Various embodiments may improve the operation of the UE by improving the efficiency with which the UE uses network resources, thereby reducing superfluous network signaling and reducing network congestion. In various embodiments, by using the first retry timer in the first network communication module and the second retry timer in the second network communication module, the UE may maintain context information about attempts to establish communication with the first communication network. In various embodiments, the UE also may coordinate (control) attempts to establish communication with the first communication network and with the second communication network.

In some embodiments, the first communication network may be a cellular communication network and the second communication network may be a satellite communication network. However, in various embodiments, the first communication network and the second communication network may be any other type of networks. Further, the communications between the UE and the networks may be voice, Short Message Service (SMS), Multimedia Messaging Service (MMS), Push-To-Talk (PTT), and other suitable communications.

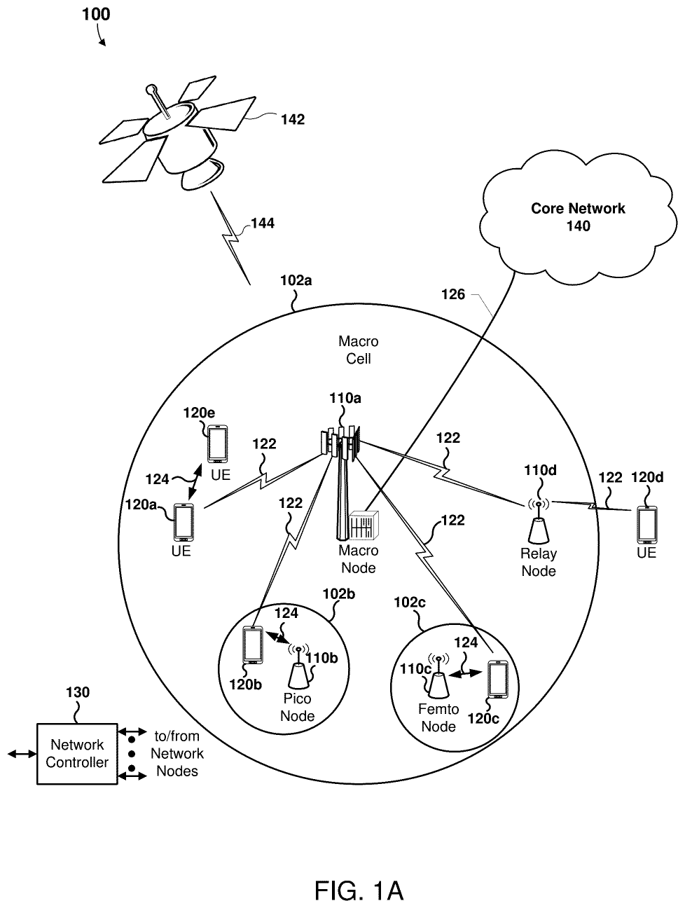

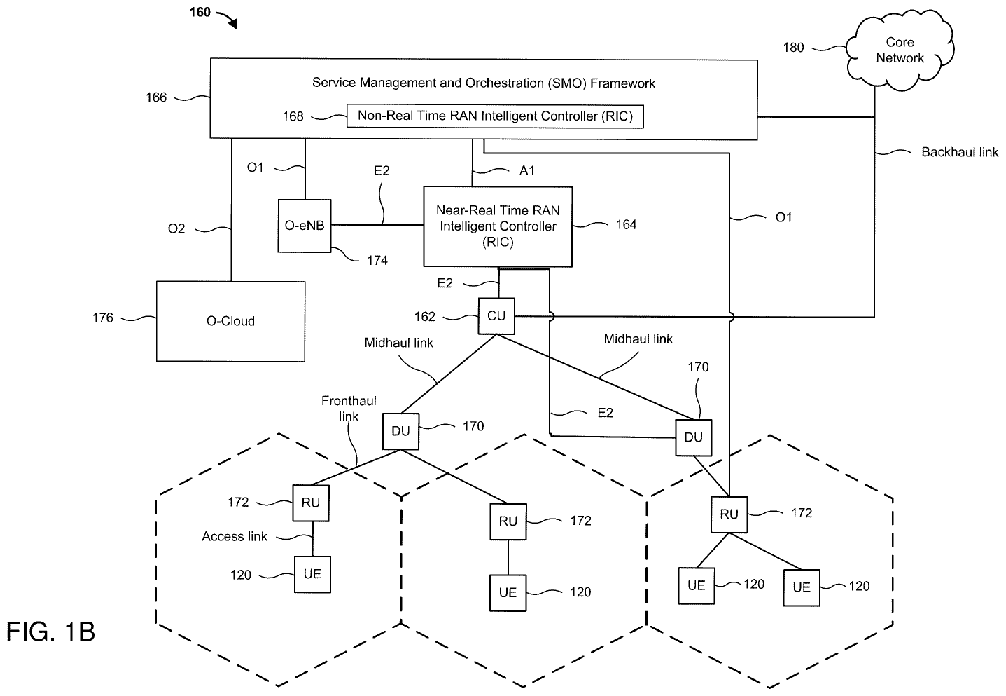

FIG. 1A is a system block diagram illustrating an example communications system 100 suitable for implementing any of the various embodiments. The communications system 100 may include a terrestrial cellular communication network, such as a 5G New Radio (NR) network, a Long Term Evolution (LTE) network, a GSM network, and the like. While FIG. 1A illustrates aspects of a 5G network, later generation networks may include the same or similar elements. Therefore, references to a 5G network and 5G network elements in the following descriptions is for illustrative purposes and is not intended to be limiting.

The communications system 100 may include a heterogeneous network architecture that includes a core network 140 and a variety of UEs (illustrated as UEs 120a-120e in FIG. 1A). The communications system 100 also may include a number of network devices 110a, 110b, 110c, and 110d and other network entities, such as base stations and network nodes. A network device is an entity that communicates with UEs, and in various embodiments may be referred to as a Node B, an LTE Evolved nodeB (eNodeB or eNB), an access point (AP), a radio head, a transmit receive point (TRP), a New Radio base station (NR BS), a 5G NodeB (NB), a Next Generation NodeB (gNodeB or gNB), or the like. In various communication network implementations or architectures, a network device may be implemented as an aggregated base station, as a disaggregated base station, an integrated access and backhaul (IAB) node, a relay node, a sidelink node, etc., such as a virtualized Radio Access Network (vRAN) or Open Radio Access Network (O-RAN). Also, in various communication network implementations or architectures, a network device (or network entity) may be implemented in an aggregated or monolithic base station architecture, or alternatively, in a disaggregated base station architecture, may include one or more of a Centralized Unit (CU), a Distributed Unit (DU), a Radio Unit (RU), a near-real time (RT) RAN intelligent controller (RIC), or a non-real time RIC. Each network device may provide communication coverage for a particular geographic area. In 3GPP, the term “cell” can refer to a coverage area of a network device, a network device subsystem serving this coverage area, or a combination thereof, depending on the context in which the term is used. The core network 140 may be any type core network, such as an LTE core network (e.g., an evolved packet core (EPC) network), 5G core network, etc.

The communications system 100 also may include a satellite communication network 142 accessible by UEs equipped with a satellite communication module (a second network communication module) via one or more communication satellites. UEs equipped with a satellite communication module may access the satellite communication network 142 as an alternative to a terrestrial communication network. For example, if a UE moves out of range of network devices 110a-110d, a UE may attempt to establish communication with a communication satellite. In some implementations, the satellite communication system 142 may utilize a network of satellites in orbit around Earth to transmit information between two points on the ground, in which a communication satellite may operate as a relay station between the two points, allowing a UE to maintain communication via the communications system 100. A UE may communication with a communication satellite over a wireless communication link 144.

A network device 110a-110d may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A network device for a macro cell may be referred to as a macro node or macro base station. A network device for a pico cell may be referred to as a pico node or a pico base station. A network device for a femto cell may be referred to as a femto node, a femto base station, a home node or home network device. In the example illustrated in FIG. 1A, a network device 110a may be a macro node for a macro cell 102a, a network device 110b may be a pico node for a pico cell 102b, and a network device 110c may be a femto node for a femto cell 102c. A network device 110a-110d may support one or multiple (for example, three) cells. The terms “network device,” “network node,” “eNB,” “base station,” “NR BS,” “gNB,” “TRP,” “AP,” “node B,” “5G NB,” and “cell” may be used interchangeably herein.

In some examples, a cell may not be stationary, and the geographic area of the cell may move according to the location of a network device, such as a network node or mobile network device. In some examples, the network devices 110a-110d may be interconnected to one another as well as to one or more other network devices (e.g., base stations or network nodes (not illustrated)) in the communications system 100 through various types of backhaul interfaces, such as a direct physical connection, a virtual network, or a combination thereof using any suitable transport network.

The network device 110a-110d may communicate with the core network 140 over a wired or wireless communication link 126. The UE 120a-120e may communicate with the network node 110a-110d over a wireless communication link 122. The wired communication link 126 may use a variety of wired networks (such as Ethernet, TV cable, telephony, fiber optic and other forms of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

The communications system 100 also may include relay stations (such as relay network device 110d). A relay station is an entity that can receive a transmission of data from an upstream station (for example, a network device or a UE) and transmit the data to a downstream station (for example, a UE or a network device). A relay station also may be a UE that can relay transmissions for other UEs. In the example illustrated in FIG. 1A, a relay station 110d may communicate with the network device 110a and the UE 120d in order to facilitate communication between the network device 110a and the UE 120d. A relay station also may be referred to as a relay network device, a relay base station, a relay, etc.

A network controller 130 may couple to a set of network devices and may provide coordination and control for these network devices. The network controller 130 may communicate with the network devices via a backhaul. The network devices also may communicate with one another, for example, directly or indirectly via a wireless or wireline backhaul.

The UEs 120a, 120b, 120c may be dispersed throughout communications system 100, and each UE may be stationary or mobile. A UE also may be referred to as an access terminal, a terminal, a mobile station, a subscriber unit, a station, wireless device, etc.

A macro network device 110a may communicate with the communication network 140 over a wired or wireless communication link 126. The UEs 120a, 120b, 120c may communicate with a network device 110a-110d over a wireless communication link 122.

The wireless communication links 122, 124, and 144 may include a plurality of carrier signals, frequencies, or frequency bands, each of which may include a plurality of logical channels. The wireless communication links 122, 124, and 144 may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE). Examples of wireless communication links 144 for use in satellite communications include links using frequencies in the 1-2 GHZ L band (e.g., for Iridium® satellite communications), band n53 (e.g., for Globalstar® satellite communication), and other suitable frequency bands.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHZ (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using Time Division Duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per UE. Multi-layer transmissions with up to 2 streams per UE may be supported. Aggregation of multiple cells may be supported with up to eight serving cells. Alternatively, NR may support a different air interface, other than an OFDM-based air interface.

Some UEs may be considered machine-type communication (MTC) or evolved or enhanced machine-type communication (eMTC) UEs. MTC and eMTC UEs include, for example, robots, remote devices, sensors, meters, monitors, location tags, etc., that may communicate with a network device, another device (for example, remote device), or some other entity. A wireless computing platform may provide, for example, connectivity for or to a network (for example, a wide area network such as Internet or a cellular network) via a wired or wireless communication link. Some UEs may be considered Internet-of-Things (IoT) devices or may be implemented as NB-IoT (narrowband internet of things) devices. The UE 120a-120e may be included inside a housing that houses components of the UE 120a-120e, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, 4G/LTE and/or 5G/NR RAT networks may be deployed. For example, a 5G non-standalone (NSA) network may utilize both 4G/LTE RAT in the 4G/LTE RAN side of the 5G NSA network and 5G/NR RAT in the 5G/NR RAN side of the 5G NSA network. The 4G/LTE RAN and the 5G/NR RAN may both connect to one another and a 4G/LTE core network (e.g., an EPC network) in a 5G NSA network. Other example network configurations may include a 5G standalone (SA) network in which a 5G/NR RAN connects to a 5G core network.

In some implementations, two or more UEs 120a-120e (for example, illustrated as the UE 120a and the UE 120e) may communicate directly using one or more sidelink channels 124 (for example, without using a network node 110a-110d as an intermediary to communicate with one another). For example, the UEs 120a-120e may communicate using peer-to-peer (P2P) communications, device-to-device (D2D) communications, a mesh network, or similar networks, a vehicle-to-everything (V2X) protocol (which may include a vehicle-to-vehicle (V2V) protocol, a vehicle-to-infrastructure (V2I) protocol, or a similar protocol), or combinations thereof. In this case, the UE 120a-120e may perform scheduling operations, resource selection operations, as well as other operations described elsewhere herein as being performed by the network node 110a-110d.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or components) performing base station functionality, may be implemented in an aggregated or disaggregated architecture. For example, a base station (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or as a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CUs, DUs and RUs also can be implemented as virtual units, referred to as a virtual central unit (VCU), a virtual distributed unit (VDU), or a virtual radio unit (VRU).

Base station-type operations or network design may consider aggregation characteristics of base station functionality. For example, disaggregated base stations may be utilized in an integrated access backhaul (IAB) network, an open radio access network (O-RAN) (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 1B is a system block diagram illustrating an example disaggregated base station 160 architecture suitable for implementing any of the various embodiments. With reference to FIGS. 1A and 1B, the disaggregated base station 160 architecture may include one or more central units (CUs) 162 that can communicate directly with a core network 180 via a backhaul link, or indirectly with the core network 180 through one or more disaggregated base station units, such as a Near-Real Time (Near-RT) RAN Intelligent Controller (RIC) 164 via an E2 link, or a Non-Real Time (Non-RT) RIC 168 associated with a Service Management and Orchestration (SMO) Framework 166, or both. A CU 162 may communicate with one or more distributed units (DUs) 170 via respective midhaul links, such as an F1 interface. The DUs 170 may communicate with one or more radio units (RUS) 172 via respective fronthaul links. The RUs 172 may communicate with respective UEs 120 via one or more radio frequency (RF) access links. In some implementations, the UE 120 may be simultaneously served by multiple RUs 172.

Each of the units (i.e., CUs 162, DUs 170, RUs 172), as well as the Near-RT RICs 164, the Non-RT RICs 168 and the SMO Framework 166, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 162 may host one or more higher layer control functions. Such control functions may include the radio resource control (RRC), packet data convergence protocol (PDCP), service data adaptation protocol (SDAP), or the like. Each control function may be implemented with an interface configured to communicate signals with other control functions hosted by the CU 162. The CU 162 may be configured to handle user plane functionality (i.e., Central Unit-User Plane (CU-UP)), control plane functionality (i.e., Central Unit-Control Plane (CU-CP)), or a combination thereof. In some implementations, the CU 162 can be logically split into one or more CU-UP units and one or more CU-CP units. The CU-UP unit can communicate bidirectionally with the CU-CP unit via an interface, such as the E1 interface when implemented in an O-RAN configuration. The CU 162 can be implemented to communicate with DUs 170, as necessary, for network control and signaling.

The DU 170 may correspond to a logical unit that includes one or more base station functions to control the operation of one or more RUs 172. In some aspects, the DU 170 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 170 may further host one or more low PHY layers. Each layer (or module) may be implemented with an interface configured to communicate signals with other layers (and modules) hosted by the DU 170, or with the control functions hosted by the CU 162.

Lower-layer functionality may be implemented by one or more RUs 172. In some deployments, an RU 172, controlled by a DU 170, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 172 may be implemented to handle over the air (OTA) communication with one or more UEs 120. In some implementations, real-time and non-real-time aspects of control and user plane communication with the RU(s) 172 may be controlled by the corresponding DU 170. In some scenarios, this configuration may enable the DU(s) 170 and the CU 162 to be implemented in a cloud-based RAN architecture, such as a vRAN architecture.

The SMO Framework 166 may be configured to support RAN deployment and provisioning of non-virtualized and virtualized network elements. For non-virtualized network elements, the SMO Framework 166 may be configured to support the deployment of dedicated physical resources for RAN coverage requirements, which may be managed via an operations and maintenance interface (such as an O1 interface). For virtualized network elements, the SMO Framework 166 may be configured to interact with a cloud computing platform (such as an open cloud (O-Cloud) 176) to perform network element life cycle management (such as to instantiate virtualized network elements) via a cloud computing platform interface (such as an O2 interface). Such virtualized network elements can include, but are not limited to, CUs 162, DUs 170, RUs 172 and Near-RT RICs 164. In some implementations, the SMO Framework 166 may communicate with a hardware aspect of a 4G RAN, such as an open eNB (O-eNB) 174, via an O1 interface. Additionally, in some implementations, the SMO Framework 166 may communicate directly with one or more RUs 172 via an O1 interface. The SMO Framework 166 also may include a Non-RT RIC 168 configured to support functionality of the SMO Framework 166.

The Non-RT RIC 168 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 164. The Non-RT RIC 168 may be coupled to or communicate with (such as via an A1 interface) the Near-RT RIC 164. The Near-RT RIC 164 may be configured to include a logical function that enables near-real-time control and optimization of RAN elements and resources via data collection and actions over an interface (such as via an E2 interface) connecting one or more CUs 162, one or more DUs 170, or both, as well as an O-eNB, with the Near-RT RIC 164.

In some implementations, to generate AI/ML models to be deployed in the Near-RT RIC 164, the Non-RT RIC 168 may receive parameters or external enrichment information from external servers. Such information may be utilized by the Near-RT RIC 164 and may be received at the SMO Framework 166 or the Non-RT RIC 168 from non-network data sources or from network functions. In some examples, the Non-RT RIC 168 or the Near-RT RIC 164 may be configured to tune RAN behavior or performance. For example, the Non-RT RIC 168 may monitor long-term trends and patterns for performance and employ AI/ML models to perform corrective actions through the SMO Framework 166 (such as reconfiguration via 01) or via creation of RAN management policies (such as A1 policies).

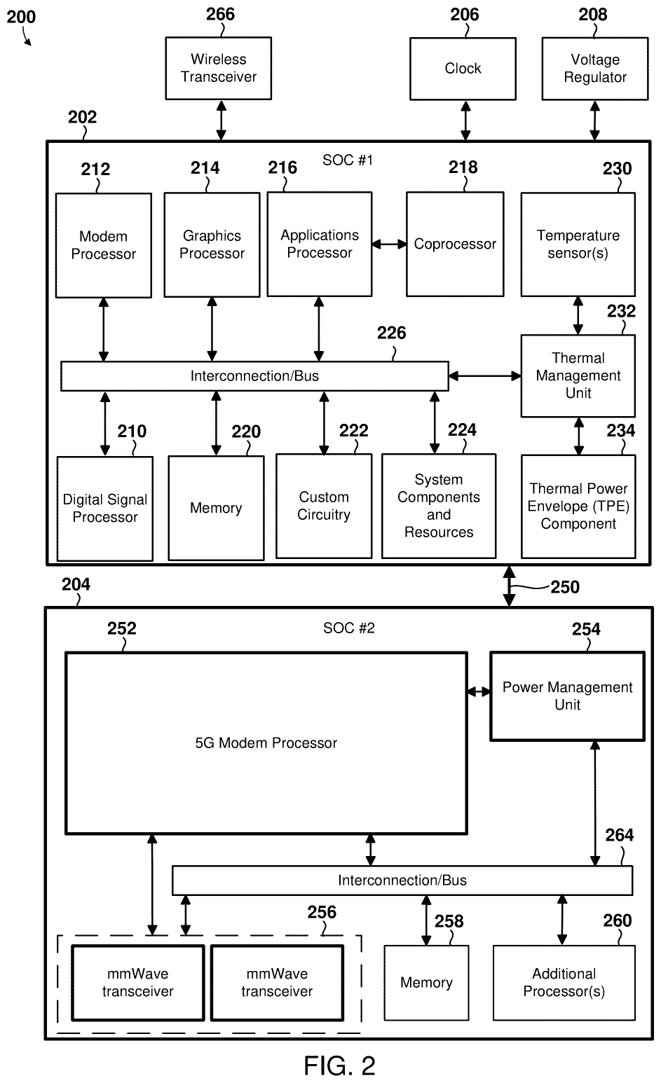

FIG. 2 is a component block diagram illustrating an example computing and wireless modem system 200 suitable for implementing any of the various embodiments. Various embodiments may be implemented on a number of single processor and multiprocessor computer systems, including a system-on-chip (SOC) or system in a package (SIP).

With reference to FIGS. 1A-2, the illustrated example computing system 200 (which may be a SIP in some embodiments) includes two SOCs 202, 204 coupled to a clock 206, a voltage regulator 208, and a wireless transceiver 266 configured to send and receive wireless communications via an antenna (not shown) to/from a UE (e.g., 120a-120e) or a network device (e.g., 110a-110d). In some implementations, the first SOC 202 may operate as central processing unit (CPU) of the UE that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), and/or very high frequency short wavelength (such as 28 GHz mm Wave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a UE. The system components and resources 224 and/or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (such as CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

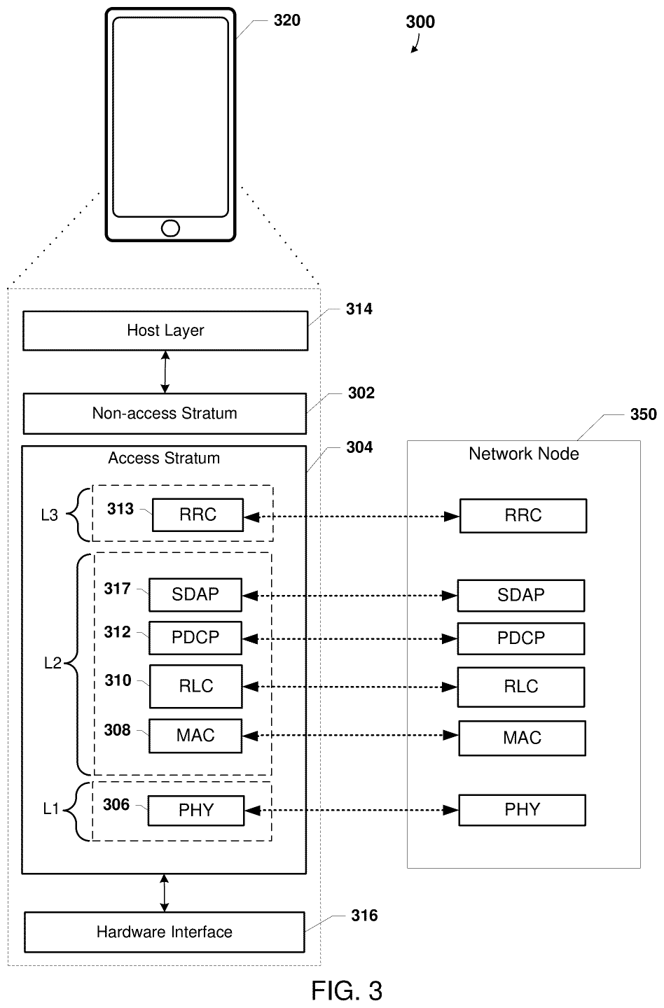

FIG. 3 is a component block diagram illustrating a software architecture 300 including a radio protocol stack for the user and control planes in wireless communications suitable for implementing any of the various embodiments. With reference to FIGS. 1A-3, the UE 320 may implement the software architecture 300 to facilitate communication between a UE 320 (e.g., the UE 120a-120e, 200) and the network device 350 (e.g., the network device 110a-110d) of a communication system (e.g., 100). In various embodiments, layers in software architecture 300 may form logical connections with corresponding layers in software of the network device 350. The software architecture 300 may be distributed among one or more processors (e.g., the processors 212, 214, 216, 218, 252, 260). While illustrated with respect to one radio protocol stack, in a UE having a multi-subscriber identity module (SIM), the software architecture 300 may include multiple protocol stacks, each of which may be associated with a different SIM (e.g., two protocol stacks associated with two SIMs, respectively, in a dual-SIM wireless communication device). While described below with reference to LTE communication layers, the software architecture 300 may support any of variety of standards and protocols for wireless communications, and/or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the UE (such as SIM(s) 204) and its core network 140. The AS 304 may include functions and protocols that support communication between a SIM(s) (such as SIM(s) 204) and entities of supported access networks (such as a network device, network node, RU, base station, etc.). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission and/or reception over the air interface via a wireless transceiver (e.g., 266). Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the UE 320 and the network node 350 over the physical layer 306. In some implementations, Layer 2 may include a media access control (MAC) sublayer 308, a radio link control (RLC) sublayer 310, and a packet data convergence protocol (PDCP) 312 sublayer, and a Service Data Adaptation Protocol (SDAP) 317 sublayer, each of which form logical connections terminating at the network node 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In some implementations, the RRC sublayer 313 may provide functions including broadcasting system information, paging, and establishing and releasing an RRC signaling connection between the UE 320 and the network node 350.

In various embodiments, the SDAP sublayer 317 may provide mapping between Quality of Service (QOS) flows and data radio bearers (DRBs). In some implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the UE 320. In some implementations, application-specific functions provided by the at least one host layer 314 may provide an interface between the software architecture and the general purpose processor (e.g., 202).

In other implementations, the software architecture 300 may include one or more higher logical layers (such as transport, session, presentation, application, etc.) that provide host layer functions. For example, in some implementations, the software architecture 300 may include a network layer (such as Internet Protocol (IP) layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency (RF) transceivers).

In various network implementations or architectures, in the network device 350 the different logical layers 308-317 may be implemented in an aggregated or monolithic base station architecture, or alternatively, in a disaggregated network device architecture, and various logical layers may implemented in one or more of a CU, a DU, an RU, a Near-RT RAN Intelligent Controller (RIC), or a Non-Real Time (Non-RT) RIC. Further, the network device 350 may be implemented as an aggregated base station, as a disaggregated base station, an integrated access and backhaul (IAB) node, a relay node, a sidelink node, etc.

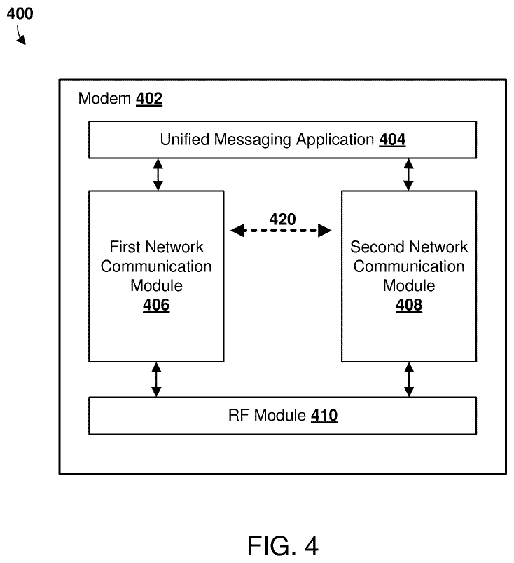

FIG. 4 is a block diagram illustrating aspects of a system 400 for managing a communication link with a network in accordance with various embodiments. In various embodiments, the system 400 may be implemented in a UE (e.g., 120a-120e, 200, 320) in hardware, software, or any combination of hardware and software. In some embodiments, the system 400 may be implemented in, or in communication with, a modem 402 or modem processor (e.g., 212, 252) of a UE.

A unified messaging application 404 may coordinate operations of, and communication between, a first network communication module 406 and a second network communication module 408. The first network communication module 406 and the second network communication module 408 may send or receive information via a communication link 420 and/or via the unified messaging application 404. Such information may include context information about the state of communication, and the history of communication, between the first network communication module 406 and a first communication network, and between the second network communication module 408 and a second communication network. The first network communication module 406 and the second network communication module 408 also may communicate with a radio frequency (RF) module 410. The RF module 410 may facilitate communication between the first network communication module 406 and the first communication network, and between the second network communication module 408 and the second communication network, via a wireless transceiver (e.g., 256, 266). In some embodiments, the RF module 410 may include two or more modules in which, for example, a first module is configured for communication with the first communication network and a second module is configured for communication with the second communication network.

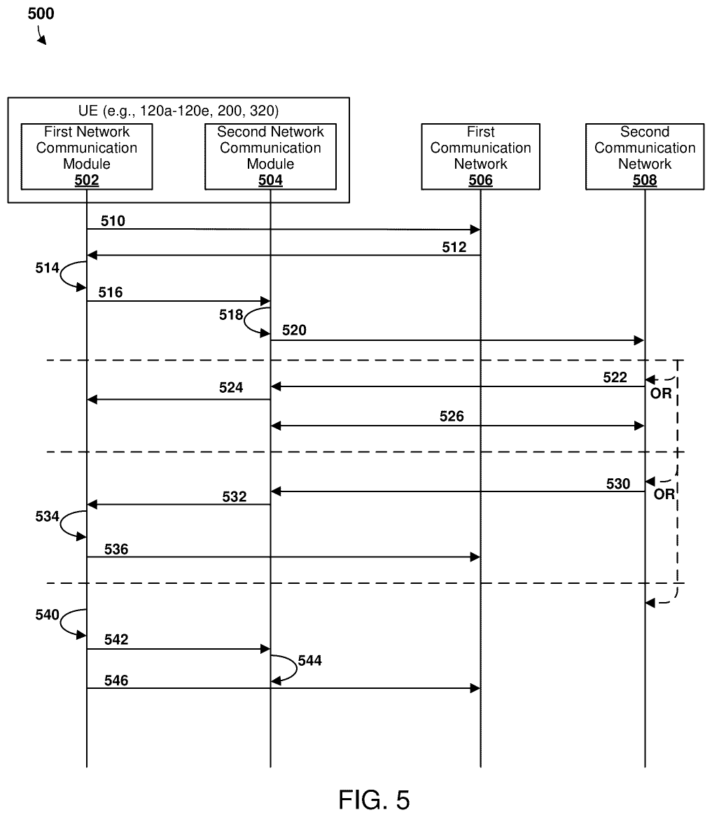

FIG. 5 is a message flow diagram illustrating a method 500 that may be performed by one or more processors of a UE for managing communication links with two different networks in accordance with various embodiments. With reference to FIGS. 1A-5, means for performing the operations of the method 500 may include a UE modem processor (e.g., the processor 212, 252) or another suitable processor (such as the processor 210, 214, 216, 218, 260) of a UE (such as the UE 120a-120e, 200, 320), referred to generally herein as a “processor.”

A first network communication module 502 of the UE may send (transmit) a service request message 510 to a first communication network 506. The first communication network 506 may be unavailable to the UE, for example, due to network congestion, network failure, or for another suitable reason. The first communication network 506 may send a connection reject message 512 to the first network communication module 502. In some embodiments the first network communication module 502 of the UE may be a terrestrial communication module configured to communicate with terrestrial cellular communication networks, such a 5G, LTE, GSM or similar cellular communication network.

In response to receiving the connection reject message 512, the first network communication module may start a first retry timer in operation 514 for a time period after which the first network communication module 502 will send a service request to the first communication network 506.

The first network communication module 502 may send a value of the first retry timer in message 516 to a second network communication module 504. In some embodiments, the value of the first retry timer may indicate an expiration time of the first timer. In some embodiments, the first retry timer may be a counter, and the value of the first retry timer may indicate a counter value. In such embodiments, the first retry timer also may indicate a maximum or threshold value of the counter. In some embodiments the second network communication module 504 of the UE may be a satellite communication module configured to communicate with satellite communication network, such Iridium®, StarLink®, Inmarsat®, or similar satellite communication networks.

The second network communication module 504 may start a second retry timer in operation 518 based on the value of the first retry timer 516. The second network communication module 504 may send a service request message 520 to a second communication network 508.

In some embodiments, the second communication network 508 may send a connection accept message 522 (e.g., a connection success message) to the second network communication module 504. The second network communication module 504 may send a connection success message 524 to the first network communication module 502 in response to establishing a communication link with the second communication network 508 before the second retry timer (started in operation 518) expires. Communications 526 may be sent to and/or from the second network communication module 504 and the second communication network 508.

In some embodiments, the second communication network 508 may send a connection reject message 530 to the second network communication module 504. In response to receiving the connection reject message 530, the second network communication module may send a connection failure message 532 to the first network communication module 502. In some embodiments, the connection failure message 532 also may include a value of the second retry timer. In some embodiments, the second network communication module may send the value of the second retry timer in an associated message, or in a different message.

The first network communication module 502 may determine that the first retry timer has expired in operation 534. In response to the first retry timer expiring, the first network communication module 502 may send a connection request message 536 (e.g., a second attempt to establish a connection) to the first communication network 506.

In some embodiments, before the first network communication module 502 receives any message from the second network communication module 504 (e.g., a message indicating connection success or connection failure with the second communication network), the first network communication module 502 may determine that the first retry timer has expired in operation 540. In response to the first retry timer expiring before the first network communication module 502 receives any message from the second network communication module 504, the first network communication module 502 may send an abort message 542 to the second network communication module 504. The abort message 542 may inform or indicate to the second network communication module 504 to abort a service request process with the second communication network 508. In response, the second network communication module 504 may abort sending a service request to the second communication network 508, or the second network communication module 504 may stop the second retry timer in operation 544. The first network communication module 502 may send a connection request message 546 (e.g., a second attempt to establish a connection) to the first communication network 506.

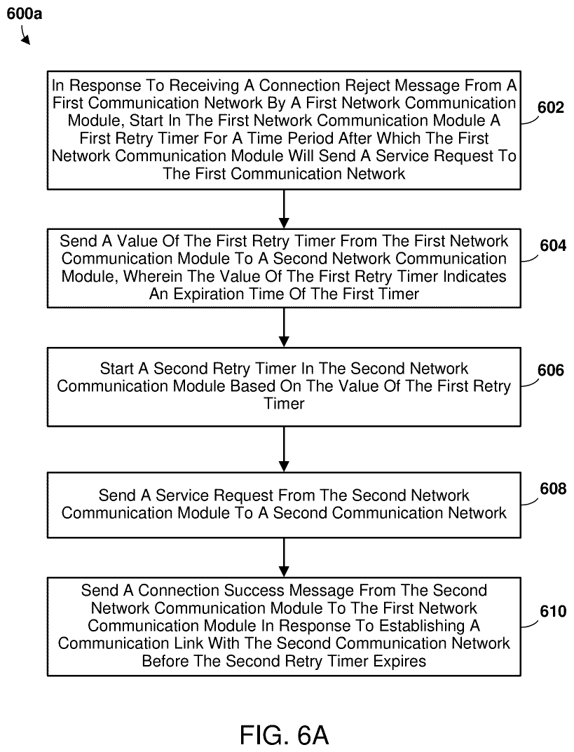

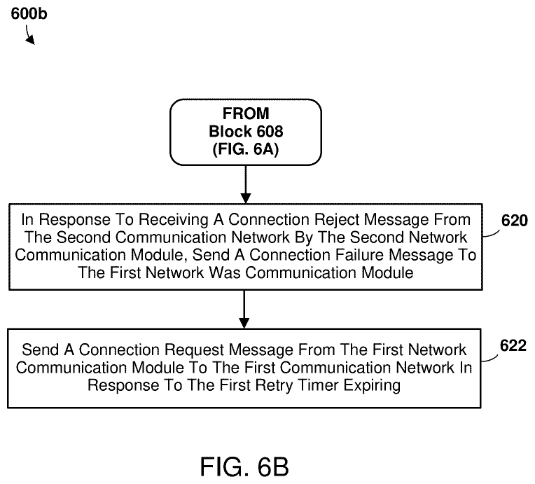

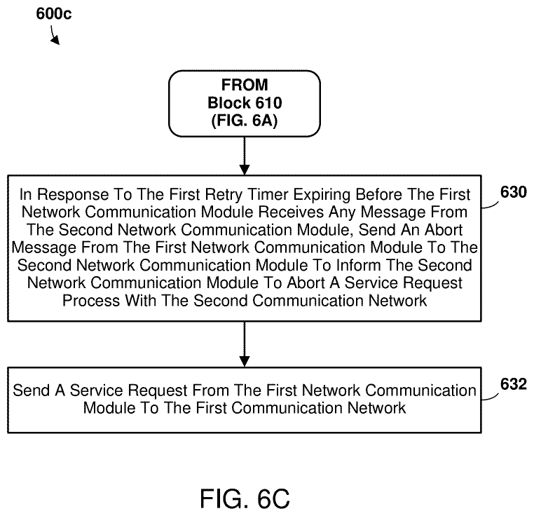

FIG. 6A is a process flow diagram illustrating a method 600a that may be performed by one or more processors of a UE for managing communication links with two different networks in accordance with various embodiments. With reference to FIGS. 1A-6A, means for performing the operations of the method 600a may include a UE modem processor (e.g., the processor 212, 252) or another suitable processor (such as the processor 210, 214, 216, 218, 260) of a UE (such as the UE 120a-120e, 200, 320), referred to generally herein as a “processor.”

In block 602, in response to receiving a connection reject message from a first communication network by a first network communication module, the processor may start in the first network communication module a first retry timer for a time period after which the first network communication module will send a service request to the first communication network. In some embodiments the first network communication module may be a terrestrial communication module configured to communicate with terrestrial cellular communication networks, such a 5G, LTE, GSM or similar cellular communication network.

In block 604, the processor may send a value of the first retry timer from the first network communication module to a second network communication module, wherein the value of the first retry timer indicates an expiration time of the first timer. In some embodiments the second network communication module may be a satellite communication module configured to communicate with satellite communication network, such Iridium®, StarLink®, Inmarsat®, or similar satellite communication networks.

In block 606, the processor may start a second retry timer in the second network communication module based on the value of the first retry timer.

In block 608, the processor may send a service request from the second network communication module to a second communication network.

In block 610, the processor may send a connection success message from the second network communication module to the first network communication module in response to establishing a communication link with the second communication network before the second retry timer expires.

FIGS. 6B and 6C are process flow diagrams illustrating operations 600b and 600c that may be performed by one or more processors of a UE modem as part of the method 600a for managing communication links with two different networks in accordance with various embodiments. With reference to FIGS. 1A-6C, means for performing the operations 600b and 600c may include a UE modem processor (e.g., the processor 212, 252) or another suitable processor (such as the processor 210, 214, 216, 218, 260) of a UE (such as the UE 120a-120e, 200, 320), referred to generally herein as a “processor.”

Referring to FIG. 6B, after the processor sends a service request from the second network communication module to a second communication network in block 608 of the method 600a as described, the processor may, in response to receiving a connection reject message from the second communication network by the second network communication module, send a connection failure message to the first network communication module in block 620. In some embodiments, the processor also may send a value of the second retry timer to the first communication module. The processor may send the value of the second retry timer with or associated with a connection failure message, or in a separate message.

In block 622, the processor may send a connection request message from the first network communication module to the first communication network in response to the first retry timer expiring.

Referring to FIG. 6C, after the processor sends a connection success message from the second network communication module to the first network communication module in block 610 of the method 600a as described, the processor may, in response to the first retry timer expiring before the first network communication module receives any message from the second network communication module, send an abort message from the first network communication module to the second network communication module to inform the second network communication module to abort a service request process with the second communication network in block 630.

In block 632, the processor may send a service request from the first network communication module to the first communication network. For example, the processor may send the service request as a second (or later) attempt to establish communication with the first communication network.

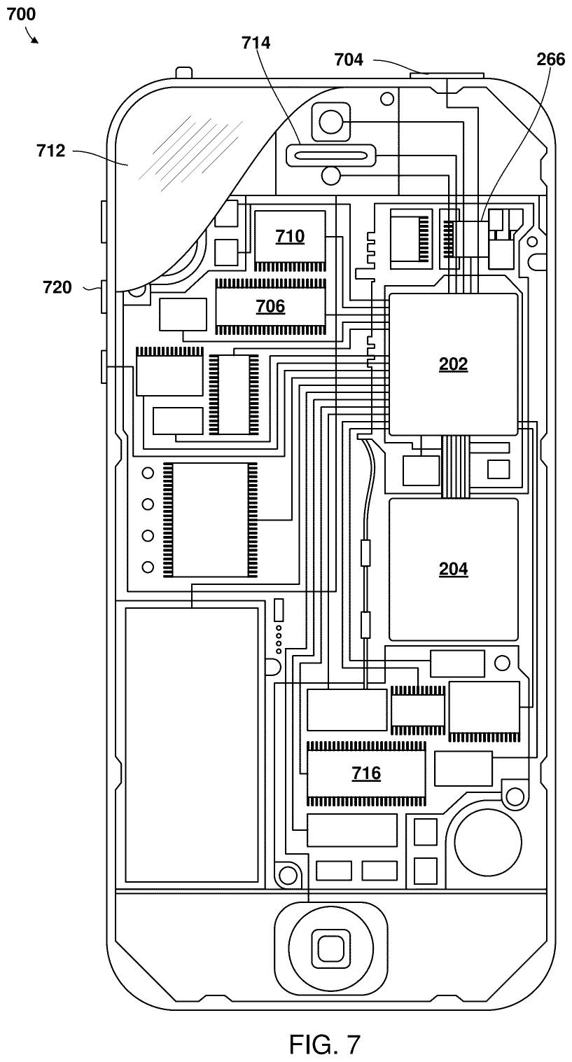

FIG. 7 is a component block diagram of a UE 700 suitable for use with various embodiments. With reference to FIGS. 1A-7, various embodiments may be implemented on a variety of UEs 700 (for example, the UEs 120a-120e, 200, 320, 420), an example of which is illustrated in FIG. 7 in the form of a smartphone. The UE 700 may include an SOC 202 (for example, a SOC-CPU) coupled to a first communication module in the form of a second SOC 204, such as a 5G communication module SOC. The UE 700 may include a second communication module 706, such as a satellite communication module configured to send and receive wireless communications with communication satellites. Additionally, the UE 700 may include an antenna 704 for sending and receiving electromagnetic radiation that may be connected to the first communication module second SOC 204 and the second communication module 706. The first and second SOCs 202, 204 and second communication module 706 may be coupled to internal memory 716, a display 712, and to a speaker 714. The UE 700 may include menu selection buttons or rocker switches 720 for receiving user inputs. The UE 700 may include a sound encoding/decoding (CODEC) circuit 710, which digitizes sound received from a microphone into data packets suitable for wireless transmission and decodes received sound data packets to generate analog signals that are provided to the speaker to generate sound. One or more of the processors in the first and second SOCs 202, 204, second communication module 706, wireless transceiver 266 and CODEC 710 may include a digital signal processor (DSP) circuit (not shown separately).

The processors of the UE 700 may be any programmable microprocessor, microcomputer or multiple processor chip or chips that can be configured by software instructions (applications) to perform a variety of functions, including the functions of some implementations described below. In some wireless devices, multiple processors may be provided, such as one processor within an SOC 204 dedicated to wireless communication functions and one processor within an SOC 202 dedicated to running other applications. Software applications may be stored in the memory 716 before they are accessed and loaded into the processor. The processors may include internal memory sufficient to store the application software instructions.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the methods and operations disclosed herein may be substituted for or combined with one or more operations of the methods and operations disclosed herein.

Implementation examples are described in the following paragraphs. While some of the following implementation examples are described in terms of example methods, further example implementations may include: the example methods discussed in the following paragraphs implemented by a UE including a processor (e.g., a modem processor or another suitable processor) configured with processor-executable instructions to perform operations of the methods of the following implementation examples; the example methods discussed in the following paragraphs implemented by a UE including means for performing functions of the methods of the following implementation examples; and the example methods discussed in the following paragraphs may be implemented as a non-transitory processor-readable storage medium having stored thereon processor-executable instructions configured to cause a processor of a UE (e.g., a modem processor or another suitable processor) to perform the operations of the methods of the following implementation examples.

Example 1. A method of managing a communication link with a network, including, in response to receiving a connection reject message from a first communication network by a first network communication module, starting in the first network communication module a first retry timer for a time period after which the first network communication module will send a service request to the first communication network, sending a value of the first retry timer from the first network communication module to a second network communication module, in which the value of the first retry timer indicates an expiration time of the first timer, starting a second retry timer in the second network communication module based on the value of the first retry timer, sending a service request from the second network communication module to a second communication network, and sending a connection success message from the second network communication module to the first network communication module in response to establishing a communication link with the second communication network before the second retry timer expires.

Example 2. The method of example 1, further including, in response to receiving a connection reject message from the second communication network by the second network communication module, sending a connection failure message to the first network communication module.

Example 3. The method of example 2, further including sending a value of the second retry timer to the first communication module.

Example 4. The method of example 2, further including sending a connection request message from the first network communication module to the first communication network in response to the first retry timer expiring.

Example 5. The method of any of examples 1-4, further including, in response to the first retry timer expiring before the first network communication module receives any message from the second network communication module, sending an abort message from the first network communication module to the second network communication module to inform the second network communication module to abort a service request process with the second communication network.

Example 6. The method of any of examples 1-5, in which the first network communication module and the second network communication module communicate via a communication interface.

Example 7. The method of example 6, in which the communication interface is managed by a unified messaging application.

Example 8. The method of any of examples 1-7, in which the first communication network is a terrestrial cellular communication network, the first network communication module is a terrestrial cellular communication module configured to communicate with the terrestrial cellular communication network, the second communication network is a satellite communication network, and the second network communication module is a satellite communication module configured to communicate with the satellite communication network.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running in a processor, a processor, an object, an executable, a thread of execution, a program, or a computer. By way of illustration, both an application running on a wireless device and the wireless device may be referred to as a component. One or more components may reside within a process or thread of execution and a component may be localized on one processor or core or distributed between two or more processors or cores. In addition, these components may execute from various non-transitory computer readable media having various instructions or data structures stored thereon. Components may communicate by way of local or remote processes, function or procedure calls, electronic signals, data packets, memory read/writes, and other known network, computer, processor, or process related communication methodologies.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G) as well as later generation 3GPP technology, global system for mobile communications (GSM), universal mobile telecommunications system (UMTS), 3GSM, general packet radio service (GPRS), code division multiple access (CDMA) systems (e.g., cdmaOne, CDMA1020™), enhanced data rates for GSM evolution (EDGE), advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), and integrated digital enhanced network (iDEN). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of managing a communication link with a network, comprising:
in response to receiving a connection reject message from a first communication network by a first network communication module, starting in the first network communication module a first retry timer for a time period after which the first network communication module will send a service request to the first communication network;
sending a value of the first retry timer from the first network communication module to a second network communication module, wherein the value of the first retry timer indicates an expiration time of the first timer;
starting a second retry timer in the second network communication module based on the value of the first retry timer;
sending a service request from the second network communication module to a second communication network; and
sending a connection success message from the second network communication module to the first network communication module in response to establishing a communication link with the second communication network before the second retry timer expires.

2. The method of claim 1, further comprising:
in response to receiving a connection reject message from the second communication network by the second network communication module, sending a connection failure message to the first network communication module.

3. The method of claim 2, further comprising sending a value of the second retry timer to the first communication module.

4. The method of claim 2, further comprising sending a connection request message from the first network communication module to the first communication network in response to the first retry timer expiring.

5. The method of claim 1, further comprising:
in response to the first retry timer expiring before the first network communication module receives any message from the second network communication module, sending an abort message from the first network communication module to the second network communication module to inform the second network communication module to abort a service request process with the second communication network.

6. The method of claim 1, wherein the first network communication module and the second network communication module communicate via a communication interface.

7. The method of claim 6, wherein the communication interface is managed by a unified messaging application.

8. The method of claim 1, wherein:
the first communication network is a terrestrial cellular communication network;
the first network communication module is a terrestrial cellular communication module configured to communicate with the terrestrial cellular communication network;
the second communication network is a satellite communication network; and
the second network communication module is a satellite communication module configured to communicate with the satellite communication network.

9. A user equipment (UE), comprising:
a memory; and
a processor coupled to the memory and configured to:
in response to receipt of a connection reject message from a first communication network by a first network communication module, start in the first network communication module a first retry timer for a time period after which the first network communication module will send a service request to the first communication network;
send a value of the first retry timer from the first network communication module to a second network communication module, wherein the value of the first retry timer indicates an expiration time of the first timer;
start a second retry timer in the second network communication module based on the value of the first retry timer;
send a service request from the second network communication module to a second communication network; and
send a connection success message from the second network communication module to the first network communication module in response to establishing a communication link with the second communication network before the second retry timer expires.

10. The UE of claim 9, wherein the processor is further configured to:
in response to receipt of a connection reject message from the second communication network by the second network communication module, send a connection failure message to the first network communication module.

11. The UE of claim 10, wherein the processor is further configured to send a value of the second retry timer to the first communication module.

12. The UE of claim 10, wherein the processor is further configured to:
send a connection request message from the first network communication module to the first communication network in response to the first retry timer expiring.

13. The UE of claim 9, wherein the processor is further configured to:
in response to the first retry timer expiring before the first network communication module receives any message from the second network communication module, send an abort message from the first network communication module to the second network communication module to inform the second network communication module to abort a service request process with the second communication network.

14. The UE of claim 9, wherein the UE further comprises a communication interface configured to enable communication between the first network communication module and the second network communication module.

15. The UE of claim 14, wherein the UE further comprises a unified messaging application configured to manage the communication interface.

16. The UE of claim 9, wherein:
the first communication network is a terrestrial cellular communication network;
the first network communication module is a terrestrial cellular communication module configured to communicate with the terrestrial cellular communication network;
the second communication network is a satellite communication network; and
the second network communication module is a satellite communication module configured to communicate with the satellite communication network.

17. A user equipment (UE), comprising:
means for starting in a first network communication module a first retry timer for a time period after which the first network communication module will send a service request to a first communication network in response to receiving a connection reject message from the first communication network by the first network communication module;
means for sending a value of the first retry timer from the first network communication module to a second network communication module, wherein the value of the first retry timer indicates an expiration time of the first timer;
means for starting a second retry timer in the second network communication module based on the value of the first retry timer;
means for sending a service request from the second network communication module to a second communication network; and
means for sending a connection success message from the second network communication module to the first network communication module in response to establishing a communication link with the second communication network before the second retry timer expires.

18. The UE of claim 17, further comprising:
means for sending a connection failure message to the first network communication module in response to receiving a connection reject message from the second communication network by the second network communication module.

19. The UE of claim 18, further comprising means for sending a value of the second retry timer to the first communication module.

20. The UE of claim 18, further comprising means for sending a connection request message from the first network communication module to the first communication network in response to the first retry timer expiring.

21. The UE of claim 17, further comprising:
means for sending an abort message from the first network communication module to the second network communication module to inform the second network communication module to abort a service request process with the second communication network in response to the first retry timer expiring before the first network communication module receives any message from the second network communication module.

22. The UE of claim 17, wherein the first network communication module and the second network communication module communicate via a communication interface.

23. The UE of claim 22, wherein the communication interface is managed by a unified messaging application.

24. The UE of claim 17, wherein:
the first communication network is a terrestrial cellular communication network;
the first network communication module is a terrestrial cellular communication module configured to communicate with the terrestrial cellular communication network;
the second communication network is a satellite communication network; and
the second network communication module is a satellite communication module configured to communicate with the satellite communication network.

25. A non-transitory processor-readable medium having stored thereon processor-executable instructions configured to cause a processing device in a user equipment (UE) to perform operations comprising:
in response to receiving a connection reject message from a first communication network by a first network communication module, starting in the first network communication module a first retry timer for a time period after which the first network communication module will send a service request to the first communication network;
sending a value of the first retry timer from the first network communication module to a second network communication module, wherein the value of the first retry timer indicates an expiration time of the first timer;
starting a second retry timer in the second network communication module based on the value of the first retry timer;
sending a service request from the second network communication module to a second communication network; and
sending a connection success message from the second network communication module to the first network communication module in response to establishing a communication link with the second communication network before the second retry timer expires.

26. The non-transitory processor-readable medium of claim 25, wherein the stored processor-executable instructions are further configured to cause the processing device in the UE to perform operations further comprising:
in response to receiving a connection reject message from the second communication network by the second network communication module, sending a connection failure message to the first network communication module.

27. The non-transitory processor-readable medium of claim 26, wherein the stored processor-executable instructions are further configured to cause the processing device in the UE to perform operations further comprising sending a value of the second retry timer to the first communication module.

28. The non-transitory processor-readable medium of claim 26, wherein the stored processor-executable instructions are further configured to cause the processing device in the UE to perform operations further comprising sending a connection request message from the first network communication module to the first communication network in response to the first retry timer expiring.

29. The non-transitory processor-readable medium of claim 25, wherein the stored processor-executable instructions are further configured to cause the processing device in the UE to perform operations further comprising:
in response to the first retry timer expiring before the first network communication module receives any message from the second network communication module, sending an abort message from the first network communication module to the second network communication module to inform the second network communication module to abort a service request process with the second communication network.

30. The non-transitory processor-readable medium of claim 25, wherein the first network communication module and the second network communication module communicate via a communication interface.
